(19) United States
(12) Patent Application Publication
(10) Pub. No.: US 2024/0039107 A1
(43) Pub. Date: Feb. 1, 2024

(54) ASSEMBLY FOR A SEALED ELECTRICAL CONNECTION

(71) Applicant: WattAlps, Moirans (FR)

(72) Inventors: Jean-Noël CARMINATI, Izeaux (FR); Matthieu DESBOIS-RENAUDIN, Villard-De-Lans (FR)

(73) Assignee: WattAlps, Moirans (FR)

(21) Appl. No.: 18/267,842

(22) PCT Filed: Dec. 17, 2021
(86) PCT No.: PCT/FR2021/052375

§ 371 Date: Jun. 16, 2023

(30) Foreign Application Priority Data
Dec. 18, 2020 (FR) FR2013732

(51) Int. Cl. H01M 50/287; H01M 50/505; H01M 10/6567; H01M 50/516; H01M 50/271; H01M 50/204

(52) U.S. Cl. CPC H01M 50/287; H01M 50/505; H01M 10/6567; H01M 50/516; H01M 50/271; H01M 50/204

(57) ABSTRACT

The present disclosure relates to an assembly for a fluidtight electrical connection, including: a wall having a first surface and a second surface, a main orifice passing through the first surface and the second surface being formed in the wall, a first groove being formed in the first surface around the main orifice, a first seal suited to being housed in the first groove and a first electronic board including at least a first sealing portion designed to compress the first seal when the first electronic board is mounted fixedly on the first surface of the wall so as to prevent a fluid from passing through the main orifice from the first surface toward the second surface of the wall.

### CROSS-REFERENCE TO RELATED APPLICATIONS

This application is a national phase entry of PCT Patent Application Serial No. PCT/FR2021/052375 filed on Dec. 17, 2021, which claims priority to French Patent Application Serial No. FR2013732 filed on Dec. 18, 2020, both of which are incorporated by reference herein.

### TECHNICAL FIELD

The present invention relates to the sealing of electrical components. More specifically, the present invention relates to the sealing of the casings of electric battery modules, typically lithium-ions type, typically immersion-cooled batteries.

### BACKGROUND

The electric batteries, such as lithium-ions batteries, comprise a positive terminal, a negative terminal, and a connector for connecting them to a device to be supplied with electrical energy. They are generally made up of modules electrically connected to each other, in series and/or in parallel, each module comprising an assembly of cells, each cell comprising an electrochemical accumulator having a nominal voltage, typically 3.7 V, each module thus having voltages generally less than 60 V. This assembly in particular makes it possible to reach electrical energy levels compatible with some applications, such as transport. Furthermore, the modules can be very easily handled.

In this type of batteries, it is important to be able to continuously measure the voltage delivered by each cell, but also their temperature, to prevent their overheating. Furthermore, it is essential to be able to electrically isolate each module to protect their users. Finally, each module and/or each battery must be sufficiently sealed to withstand the external projections, typically of liquid, but also prevent air humidity from entering the module.

Some of these batteries are cooled by immersion in a dielectric fluid. This type of cooling requires ensuring the internal sealing and external sealing, both at the level of the module and of the battery, that is to say it is necessary to prevent any circulation of liquid from the external environment to the interior of the module or of the battery, but also from the interior of the module or of the battery to the external environment. This sealing must also not oppose the transmission of information, typically concerning the voltage and the temperature of each cell, between the interior and the exterior of a module, for example by electronic means.

A known way to ensure this sealing consists in using electronic connectors that are sealed against the circulation of fluid from the exterior to the interior of the cell, then in adding a potting resin to make these connectors sealed against the circulation of fluid from the interior to the exterior of the cell. However, this technique is complex and expensive. Furthermore, it does not provide complete satisfaction since the fluid can travel back by capillarity inside the electrical connection cables used to connect the cell to the external environment. Finally, it hinders the dismounting of the module, which is necessary for example with a view to its recycling.

There is therefore a need to overcome at least one of the drawbacks of the state of the art.

### SUMMARY

One aim of the invention is to ensure the sealing of an electronic connector of a battery module, both from the exterior of the module to the interior of the module, and from the interior of the module to the exterior of the module. For this purpose, there is proposed, according to one aspect of the invention, an assembly for a sealed electrical connection comprising:
a wall having a first surface and a second surface, the second surface being opposite to the first surface, a main orifice passing through the first surface and the second surface being formed within the wall for the arrangement of an electrical connector, a first groove being formed within the first surface around the main orifice, a second groove is formed within the second surface of the wall, around the main orifice,
a first seal adapted to be housed inside the first groove and a second seal adapted to be housed inside the second groove,
a first electronic board adapted to be connected to the electrical connector and comprising at least a first sealing portion adapted to compress the first seal when the first electronic board is fixedly mounted on the first surface of the wall, so as to prevent the circulation of a fluid through the main orifice, from the first surface to the second surface of the wall, and
a second electronic board adapted to be connected to the electrical connector and to cooperate with the second seal, so as to prevent the circulation of a fluid through the main orifice, from the second surface to the first surface of the wall.

Thanks, in particular, to the interaction between the first electronic board and the first seal, it is possible to guarantee the sealing through the wall. This makes it possible to prevent the circulation of a fluid from the area where the first electronic board extends, typically the interior of a battery module casing, towards the opposite area relative to the wall, typically the exterior of the battery module casing.

Advantageously, but optionally, the assembly can comprise the at least one among the following characteristics, taken alone or in any combination:
the first electronic board is rigid,
at least a first electrical connection orifice is formed through the first electronic board, a first electronic component extending within the first electrical connection orifice by being soldered to the first electronic board, the first electrical connection orifice being moreover filled with a brazing material to prevent the circulation of a fluid through the main orifice, from the first surface to the second surface of the wall,
the first electronic board is flexible,
the first electronic board comprises a rigid extra thickness forming the first sealing portion,
at least a first electrical connection orifice is formed through the first electronic board and in the rigid extra thickness, a first electronic component extending within the first electrical connection orifice by being soldered to the first electronic board, the first electrical connection orifice being moreover filled with a brazing material to prevent the circulation of a fluid through the main orifice, from the first surface to the second surface of the wall,
it comprises a first coating surrounding at least part of the first electronic board, at least a portion of the first coating forming the first sealing portion,
at least a first through-via is formed in the first electronic board and the portion of the first coating forming the first sealing portion, the first through-via being positioned so as to ensure an electrical connection between, on the one hand, a first electronic track arranged on the first electronic board and encapsulated in the first coating and, on the other hand, an electrical connector,
the first electronic board is fixedly mounted on the first surface of the wall by screwing,
the second groove extends at a distance from the main orifice and surrounds the main orifice,
the second electronic board comprises at least a second sealing portion adapted to compress the second seal when the second electronic board is fixedly mounted on the second surface of the wall,
it comprises a second coating surrounding the second electronic board and adapted to ensure the mounting of the second electronic board on the second surface of the wall,
it comprises a second coating surrounding the second electronic board and adapted to ensure the mounting of the second electronic board on the second surface of the wall, the second coating being further adapted to compress the second seal when the second electronic board is fixedly mounted on the second surface of the wall,
at least a second through-via is formed in the second electronic board, the second through-via being positioned so as to ensure an electrical connection between, on the one hand, a second electronic track formed on the second electronic board and encapsulated in the second coating and, on the other hand, an electrical connector,
at least a second electrical connection orifice is formed through the second electronic board, a second electronic component extending within the second electrical connection orifice by being soldered to the second electronic board (4), the second electrical connection orifice being moreover filled with a brazing material to prevent the circulation of a fluid through the main orifice, from the second surface to the first surface of the wall,
the second electronic board is fixedly mounted on the second surface of the wall by screwing,
it comprises an electrical connector arranged inside the main orifice, the electrical connector being connected to the first electronic board and to the second electronic board to transmit an electrical signal between the first electronic board and the second electronic board,
a discharge orifice is formed through the second electronic board and the second coating, and opens out, on the one hand, within the main orifice and, on the other hand, at the level of an external surface of the second coating, opposite to the second surface of the wall, the assembly further comprising a membrane fixedly mounted on the second coating, at the level of the external surface of the second coating, so as to:
prevent a circulation of liquid within the discharge orifice, from the external surface of the second coating to the main orifice, and
authorize a circulation of air within the discharge orifice, from the main orifice to the external surface of the second coating.

According to another aspect of the invention, there is proposed an immersion-cooled electric battery module, comprising:
a casing comprising a plurality of walls defining a sealed enclosure, a plurality of electrochemical accumulators being arranged within the enclosure, and
an assembly as previously described,
in which a wall of the casing forms the wall of the assembly, the first surface of the wall facing the enclosure.
   Advantageously, but optionally, the casing comprises a housing with a substantially parallelepiped shape and two covers hermetically closing the housing, in which the wall of the assembly is a wall of one of the two covers.

### BRIEF DESCRIPTION OF THE DRAWINGS

Other characteristics, aims and advantages of the invention will emerge from the following description, which is purely illustrative and not limiting, and which should be read in relation to the appended drawings in which:

FIG. 1 illustrates a perspective view of an electric battery module and of an external electronic board.

FIG. 2 illustrates an exploded view of an assembly for a sealed electrical connection according to one exemplary embodiment of the invention.

FIG. 3 illustrates a sectional view of an assembly for a sealed electrical connection according to one exemplary embodiment of the invention.

FIG. 4 illustrates a sectional view of an assembly for a sealed electrical connection according to one exemplary embodiment of the invention.

In all the figures, the similar elements bear identical references.

### DETAILED DESCRIPTION

In all that follows, it is meant by “flexible” the property of an element of being able to deform and/or bend without breaking, typically so as to be able to be inserted into a housing whose dimensions are smaller than at least one dimension of the flexible element. More specifically, a flexible element is deformable according to a minimum radius of curvature greater than or equal to 0.5 millimeters and less than or equal to 5 millimeters.

Likewise, it is meant by “rigid” the property of an element of being able to be compressed without deforming and/or breaking, typically in order to be able to transmit a pressure to ensure a sealed connection. More specifically, a rigid element has a Young's modulus greater than or equal to 5 GPa and less than or equal to 50 GPa, and/or has a flexural strength greater than or equal to 150 MPa and less than or equal to 1,000 MPa.

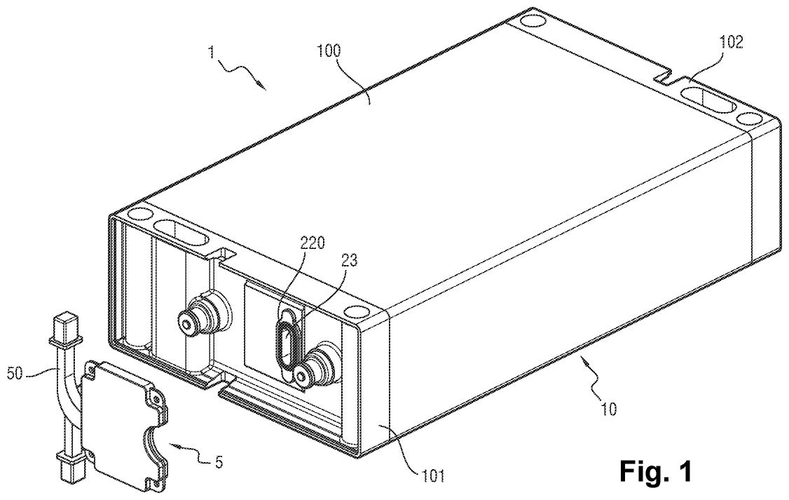

Referring to FIG. 1, an electric battery comprises a plurality of modules 1 electrically connected to each other, in series and/or in parallel. The electric battery is typically of the lithium-ions type.

Each module 1 comprises a casing 10, or box, comprising a plurality of walls 2, typically a housing 100 having a substantially parallelepiped shape and two covers 101, 102 hermetically closing the housing 100, together defining a sealed enclosure 1000. The term “sealed” here means a sealing against any type of fluid element, such as water and/or air, whether in their movement from the exterior to the interior of the enclosure 1000, or from the interior to the exterior of the enclosure 1000.

An assembly of cells is arranged within the enclosure 1000, each cell comprising an electrochemical accumulator. Such electric batteries have for example been described in document WO 2020/109714, in the name of the Applicant.

In order to be able to measure at least one among the voltage delivered by each cell and the temperature of each cell, at least one sensor is arranged inside the enclosure 1000. This sensor is configured to emit a signal, preferably electrical signal, as a function of voltage and/or temperature values recorded at the level of one or more cells. This signal must then be collected to be processed outside the enclosure 1000.

Referring to FIG. 1, in order to transit this signal emitted by the sensor from the interior to the exterior of the enclosure 1000, an external electronic board 5 is advantageously brought at the level of an external surface of a wall 2 of the casing 10, preferably a wall 2 of one of the two covers 101, 102, as shown in FIG. 1. An element “external” to the casing 10 is here defined as an element which is not in contact with the enclosure 1000 defined by the casing 10. Conversely, an element “internal” to the casing 10, such as the sensor or the cells, is here defined as an element which is in contact with the enclosure 1000 defined by the casing 10.

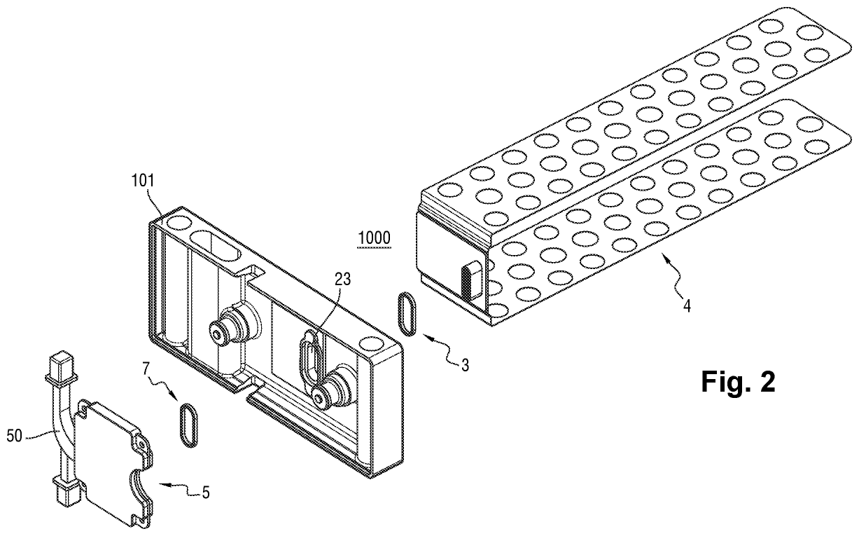

As shown in FIG. 1, connectors 50, preferably of the electrical type, are advantageously connected to the external electronic board 5, so as to transit a signal from the external electronic board 5 to another element of the electric battery, typically a server for controlling the electric battery. Referring to FIGS. 2 to 4, with a view to transiting the signal emitted by the sensor from the interior of the enclosure 1000 to the external electronic board 5, an internal electronic board 4 is brought at the level of an internal surface 21 of a wall 2 of the casing 10, preferably of the wall 2 of the casing 10 onto which the external electronic board 5 is brought, for example the wall 2 of one of the two covers 101, 102, as shown in FIG. 2.

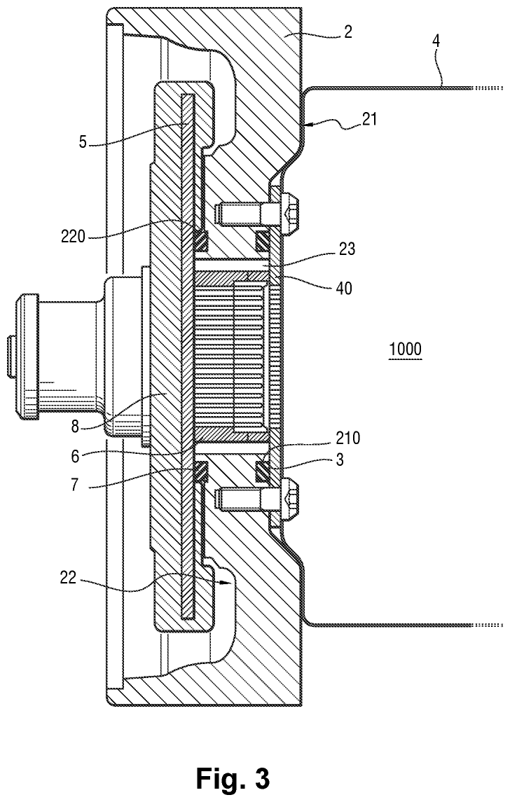

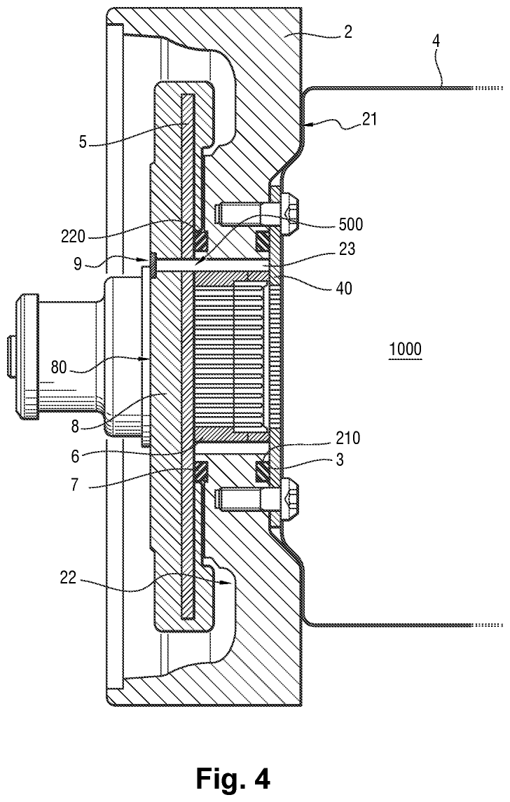

Referring to FIGS. 3 and 4, the wall 2 of the casing 10, onto which the internal electronic board 4 and the external electronic board 5 are brought, therefore has an internal surface 21 and an external surface 22, opposite to the internal surface 21. As shown in FIGS. 3 and 4, but also in FIGS. 1 and 2, a main orifice 23 passing through the internal surface 21 and the external surface 22 is advantageously formed within the wall 2.

As shown in FIGS. 3 and 4, an electrical connector 6 is advantageously arranged inside the main orifice 23. The electrical connector 6 is connected to the external electronic board 5 and to the internal electronic board 4 to transmit the signal emitted by the sensor between the internal electronic board 4 and the external electronic board 5. In one advantageous variant, the electrical connector 6 comprises a first portion connected to the external electronic board 5, preferably through a fixed mounting of the first portion on the external electronic board 5, typically by soldering, and a second portion connected to the internal electronic board 4, preferably through a fixed mounting of the second portion on the internal electronic board 4, typically by soldering. In this variant, the first portion and the second portion are each configured to interlock with each other. Advantageously, a tolerance, preferably of at least 0.2 millimeters, is provided for the stroke necessary for the electrical connection of the first portion and of the second portion of the electrical connector 6. Thus, the signal is indeed transmitted between the internal electronic board 4 and the external electronic board 5. Indeed, thanks to the clearance authorized between the first portion and the second portion, the electrical contact is established despite the deviations in dimensions between the different parts.

Since the presence of the main orifice 23 is likely to lead to a loss of sealing of the module through the wall 2 within which the main orifice 23 is formed, it is important to prevent the circulation of a fluid from the interior to the exterior of the enclosure 1000, through the main orifice 23. In this respect, as seen in FIGS. 3 and 4, an internal groove 210 is formed within the internal surface 21 of the wall 2, around the main orifice 23. Furthermore, an internal seal 3 is adapted to be housed inside the internal groove 210, as shown in FIGS. 2 to 4. Finally, the internal electronic board 4 comprises at least a first sealing portion 40 adapted to compress the internal seal 3 when the internal electronic board 4 is fixedly mounted on the internal surface 21 of the wall 2. In this way, the circulation of a fluid through the main orifice 23, from the internal surface 21 to the external surface 22 of the wall 2, is prevented. The first sealing portion 40 of the internal electronic board 4 can be made in different ways, depending, for example, on whether the internal electronic board 4 is rigid or flexible.

In one embodiment where the internal electronic board 4 is rigid, the first sealing portion 40 consists of any part of the internal electronic board 4 capable of compressing the internal seal 3 when the first flexible electronic board is fixedly mounted on the internal surface 21 of the wall 2. Advantageously, the internal electronic board 4 is fixedly mounted on the internal surface 21 of the wall 2 by screwing of at least part of the rigid internal electronic board 4 on the internal surface of the wall 2.

In one embodiment where the internal electronic board 4 is flexible, as illustrated in FIGS. 2 to 4, the internal electronic board 4 can, in a first variant illustrated in FIGS. 2 to 4, comprise a rigid extra thickness 40 forming the first sealing portion 40. Advantageously, as shown in FIGS. 2 to 4, the internal electronic board 4 is fixedly mounted on the internal surface 21 of the wall 2 by screwing of at least part of the rigid extra thickness 40 of the internal electronic board 4 on the internal surface 21 of the wall 2.

In a second variant of this embodiment, a first coating surrounds at least a part of the internal electronic board 4. The first coating can, for example, take the form of an Epoxy electronic board resin coating, of a pressurized encapsulation resin or of glue. In this case, at least a portion of the first coating forms the first sealing portion 40. Advantageously, the internal electronic board 4 is fixedly mounted on the internal surface 21 of the wall 2 by screwing of at least part of the first coating on the internal surface 21 of the wall 2. This fixing method is however not limiting since the internal electronic board 4 can itself comprise fixing means on the internal surface 21 of the wall 2, typically by screwing for example by means of openings intended to receive fixing screws.

Whatever the rigidity (or flexibility) of the internal electronic board 4, it is necessary to transit the signal from the tracks of the internal electronic board 4, which extend over the surface of the internal electronic board 4 opposite to the surface of the internal electronic board 4 which comes into contact with the internal seal 3. Furthermore, this transmission of the signal must be able to be implemented by preserving the sealing of the casing 10, in particular by preserving the sealing of the electrical connection between the internal electronic board 4 and the external electronic board 5.

To do so, in the embodiment where the internal electronic board 4 is rigid, at least a first electrical connection orifice is advantageously formed through the internal electronic board 4, a first electronic component (or connector) extending within the first electrical connection orifice by being soldered to the internal electronic board 4. Furthermore, the first electrical connection orifice is filled with a brazing material to prevent the circulation of a fluid through the main orifice 23, from the internal surface 21 to the external surface 22 of the wall 2.

In the same way, in the first variant of the embodiment where the internal electronic board 4 is flexible, at least a first electrical connection orifice is advantageously formed through the internal electronic board 4 and in the rigid extra thickness 40, a first electronic component (or connector) extending within the first electrical connection orifice by being soldered to the internal electronic board 4. Moreover, the first electrical connection orifice is filled with a brazing material to prevent the circulation of a fluid through the main orifice 23, from the internal surface 21 to the external surface 22 of the wall 2.

Finally, in the second variant of the embodiment where the internal electronic board 4 is flexible, at least a first through-via is advantageously formed in the internal electronic board 4 and the portion of the first coating forming the first sealing portion 40, the first through-via being positioned so as to ensure an electrical connection between, on the one hand, a first electronic track arranged on the internal electronic board and encapsulated in the first coating and, on the other hand, the electrical connector 6, Generally, a via is a metallized hole which makes it possible to establish an electrical connection between two layers. This via connection mode prevents the first electronic track from creating asperities at the level of the internal seal 3, which would reduce the sealing of the interface between the internal electronic board 4 and the internal surface 21 of the wall 2.

It is further preferable to prevent the circulation of a fluid from the exterior to the interior of the enclosure 1000, through the main orifice 23. In this respect, as shown in FIGS. 1 to 4, an external groove 220 is advantageously formed within the external surface 22 of the wall 2, around the main orifice 23. Preferably, as shown in FIG. 2, the external groove 220 extends away from the main orifice 23 and surrounds the main orifice 23. In addition, an external seal 7 is adapted to be housed inside the external groove 220. The external seal 7 cooperates with the external electronic board 5 so as to prevent the circulation of a fluid through the main orifice 23, from the external surface 22 to the internal surface 21 of the wall 2. To do so, different embodiments can be envisaged.

Referring to FIGS. 1 to 4, in one embodiment, the external electronic board 5 comprises at least a second sealing portion adapted to compress the external seal 7 when the external electronic board 5 is fixedly mounted on the external surface 22 of the wall 2. In one variant of this embodiment, also illustrated in FIGS. 1 to 4, a second coating 8 surrounds the external electronic board 5. The second coating 8 is, for example, adapted to ensure the mounting of the external electronic board 5 on the external surface 22 of the wall 2, preferably by screwing. This fixing mode is however not limiting since the external electronic board 5 can itself comprise fixing means on the external surface 22 of the wall 2, typically by screwing, for example by means of openings intended to receive fixing screws, as shown in FIGS. 1 and 2. In any case, the second coating 8 is advantageously sealed in order to ensure the protection of the electronic circuits of the external electronic board 5 and the corresponding electronic components.

In another embodiment, a second coating 8 surrounds the external electronic board 5 and is adapted to compress the external seal 7 when the external electronic board 5 is fixedly mounted on the external surface 22 of the wall 2. In one variant, the second coating 8 is adapted to ensure the mounting of the external electronic board 5 on the external surface 22 of the wall 2, preferably by screwing. This fixing mode is however not limiting since the external electronic board 5 can itself comprise fixing means on the external surface 22 of the wall 2, typically by screwing, for example by means of openings intended to receive fixing screws, as shown in FIGS. 1 and 2.

Whatever the embodiment of the external electronic board 5, it is necessary to transit the signal through tracks of the external electronic board 5, which extend over the surface of the external electronic board 5 opposite to the surface of the external electronic board 5 which comes into contact with the external surface 22 of the wall 2. Furthermore, this transmission of the signal must be able to be implemented while preserving the sealing of the casing 10.

To do so, in one embodiment, at least a second through-via is formed in the external electronic board 5, the second through-via being positioned so as to ensure an electrical connection between, on the one hand, a second electronic track arranged on the external electronic board 5 and encapsulated in the second coating 8 and, on the other hand, the electrical connector 6. This connection through the via prevents the second electronic track from creating asperities at the level of the external seal 7, which would reduce the sealing of the interface between the external electronic board 5 and the external surface 22 of the wall 2.

As a variant or as a complement, at least a second electrical connection orifice is formed through the external electronic board 5, a second electronic component extending within the second electrical connection orifice by being soldered to the external electronic board 5, the second electrical connection orifice being moreover filled with a brazing material to prevent the circulation of a fluid through the main orifice 23, from the external surface 22 to the internal surface 21 of the wall 2.

In one embodiment, the external electronic board 5 is itself sealed, in particular vis-à-vis external attacks, such as rainwater. This sealing can for example be achieved by varnishing the external electronic board 5. In one embodiment, the sealing from the exterior to the interior of the enclosure 1000 can also be ensured if the portion of the electrical connector 6 connected to the external electronic board 5 and/or the portion of the electrical connector 6 connected to the internal electronic board 4, is/are sealed.

With reference to FIG. 4, in one embodiment, a discharge orifice 500 is formed through the external electronic board 5 and the second coating 8, and opens out, on the one hand, within the main orifice 23 and, on the other hand, at the level of an external surface 80 of the second coating 8, opposite to the external surface 22 of the wall 2. Furthermore, a membrane 9, preferably of the Gore type, is fixedly mounted on the second coating 8, at the level of the external surface 80 of the second coating 8, so as to:

prevent a circulation of liquid within the discharge orifice 500, from the external surface 80 of the second coating to the main orifice 23, and authorize a circulation of air (and humidity) within the discharge orifice 500, from the main orifice 23 to the external surface 80 of the second coating.

In this embodiment, the moisture that accumulates within the main orifice 23 is advantageously discharged to the exterior of the casing 10.

1. An assembly comprising:
a wall having a first surface and a second surface, the second surface being opposite to the first surface, a main orifice passing through the first surface and the second surface being formed within the wall, a first groove being formed within the first surface around the main orifice, a second groove being formed within the second, around the main orifice;
a first seal adapted to be housed inside the first groove;
a second seal adapted to be housed inside the second groove;
a first electronic board comprising at least a first sealing portion adapted to compress the first seal when the first electronic board is fixedly mounted on the first surface, so as to prevent a first circulation of a fluid through the main orifice, from the first surface to the second surface; and
a second electronic board adapted to cooperate with the second seal, so as to prevent a second circulation of a fluid through the main orifice, from the second surface to the first surface.

2. The assembly board of claim 1, wherein the first electronic board is rigid.

3. The assembly of claim 2, wherein at least a first electrical connection orifice is formed through the first electronic board, a first electronic component extending within the first electrical connection orifice by being soldered to the first electronic board, the first electrical connection orifice being further filled with a brazing material to prevent the first circulation of a fluid through the main orifice, from the first surface to the second surface.

4. The assembly of claim 1, wherein the first electronic board is flexible.

5. The assembly of claim 4, wherein the first electronic board comprises a rigid extra thickness forming the first sealing portion.

6. The assembly of claim 5, wherein at least a first electrical connection orifice is formed through the first electronic board and in the rigid extra, a first electronic component extending within the first electrical connection orifice by being soldered to the first electronic board, the first electrical connection orifice being further filled with a brazing material to prevent the circulation of a fluid through the main orifice, from the first surface to the second surface.

7. The assembly of claim 4, further comprising a first coating surrounding at least part of the first electronic board, at least a portion of the first coating forming the first sealing portion.

8. The assembly of claim 7, wherein at least a first through-via is formed in the first electronic board and the portion of the first coating forming the first sealing portion, the first through-via being positioned so as to ensure an electrical connection between, on the one hand, a first electronic track arranged on the first electronic board and encapsulated in the first coating and, on the other hand, an electrical connector.

9. The assembly of claim 1, wherein the first electronic board is fixedly mounted on the first surface by screwing.

10. The assembly of claim 1, wherein the second groove extends at a distance from the main orifice and surrounds the main orifice.

11. The assembly of claim 1, wherein the second electronic board comprises at least a second sealing portion adapted to compress the second seal when the second electronic board is fixedly mounted on the second surface.

12. The assembly of claim 11, further comprising a second coating surrounding the second electronic board and adapted to ensure a mounting of the second electronic board on the second surface.

13. The assembly of claim 1, further comprising a second coating surrounding the second electronic board and adapted to ensure the mounting of the second electronic board on the second surface, the second coating being further adapted to compress the second seal when the second electronic board is fixedly mounted on the second surface.

14. The assembly of claim 12, wherein at least a second through-via is formed in the second electronic board, the second through-via being positioned so as to ensure an electrical connection between, on the one hand, a second electronic track formed on the second electronic board and encapsulated in the second coating and, on the other hand, an electrical connector.

15. The assembly claim 11, wherein at least a second electrical connection orifice is formed through the second electronic board, a second electronic component extending within the second electrical connection orifice by being soldered to the second electronic board, the second electrical connection orifice being further filled with a brazing material to prevent the second circulation of a fluid through the main orifice, from the second surface to the first surface of the wall (2).

16. The assembly of claim 11, wherein the second electronic board is fixedly mounted on the second surface by screwing.

17. The assembly of claim 11, further comprising an electrical connector arranged inside the main orifice, the electrical connector being connected to the first electronic board and to the second electronic board to transmit an electrical signal between the first electronic board and the second electronic board.

18. The assembly of claim 12, wherein a discharge orifice is formed through the second electronic board and the second coating, and opens out, on the one hand, within the main orifice and, on the other hand, at the level of an external surface of the second coating, opposite to the second surface, the assembly further comprising a membrane fixedly mounted on the second coating, at the level of the external surface so as to:
prevent a third circulation of liquid within the discharge orifice, from the external towards the main orifice, and
authorize a fourth circulation of air within the discharge orifice, from the main orifice to the external surface of the second coating.

19. An immersion-cooled electric battery module, comprising:
a casing comprising a plurality of walls defining a sealed enclosure, a plurality of electrochemical accumulators being arranged within the enclosure; and
the assembly of claim 1,
wherein a wall of the casing forms the wall of the assembly, the first surface of the wall facing the enclosure.

20. The module of claim 19, wherein the casing comprises a housing having a substantially parallelepiped shape and two covers hermetically closing the housing, wherein the wall of the assembly is a wall of one of the two covers.
